(19) United States
(12) Patent Application Publication
(10) Pub. No.: US 2017/0160371 A1
(43) Pub. Date: Jun. 8, 2017

(54) LUMINAIRE LOCATING DEVICE, LUMINAIRE, AND LUMINAIRE CONFIGURING AND COMMISSIONING DEVICE

(71) Applicants: Zumtobel Lighting Inc., Highland, NY (US); Tridonic GmbH & Co. KG, Dornbirn (AT)

(72) Inventors: Raphael Böckle, Frastanz (AT); Mathias Burger, Bregenz (AT); Karl Jonsson, Rancho Santa Margarita, CA (US); Stefan Kohlgrüber, Feldkirch (AT); Christian Moormann, Bregenz (AT); Stephane Vasse, Mader (AT)

(21) Appl. No.: 14/959,075

(22) Filed: Dec. 4, 2015

(51) Int. Cl. G01S 3/78; G01J 1/42

(52) U.S. Cl. CPC G01S 3/78; G01J 1/42

(57) ABSTRACT

A luminaire locating device may be used to automatically determine positions of luminaires of a lighting system. The luminaire locating device may have an interface to receive intensity information captured by a plurality of optical sensors. The luminaire locating device may have an electronic processing device to process the intensity information captured by the plurality of optical sensors to determine the positions of the luminaires.

### FIELD OF THE INVENTION

Embodiments of the invention relate to lighting systems. Embodiments of the invention relate in particular to techniques operative to determine locations of luminaires, e.g. for commissioning a lighting system, and/or to techniques operative to commission a lighting system.

### BACKGROUND OF THE INVENTION

With increasing complexity of lighting systems and lighting system control, techniques of configuring and commissioning entities in a lighting system become increasingly more important. Examples of such techniques include assigning different luminaires to groups and/or light scenes, defining light scenes, or other control steps that allow the lighting system to be automatically controlled.

The commissioning of a lighting system in which different luminaires are assigned to different groups or light scenes may traditionally require a significant amount of work time and may therefore add to the costs of the lighting system. The commissioning and/or configuring may be made more complicated by the fact that it may be generally difficult for an engineer to know which luminaire has which address in the lighting system or which address in the lighting system corresponds to which one of the various devices.

### BRIEF SUMMARY OF THE INVENTION

There is a continued need in the art for devices, systems and methods operative to assist an engineer in configuring or commissioning a lighting system.

According to an embodiment, devices, systems, and methods that allow luminaires to be located automatically are provided. Luminaires or lighting systems may be operative to perform a self-localization in which two-dimensional or three-dimensional coordinates of luminaires may be determined automatically.

A luminaire locating device according to an embodiment comprises an interface to receive intensity information captured by a plurality of optical sensors. The luminaire locating device may comprise an electronic processing device to locate luminaires of a lighting system by processing the intensity information captured by the plurality of optical sensors.

The luminaire locating device may be a mobile terminal, such as a smartphone or other portable telephone. The luminaire locating device may be a server coupled the lighting system via a wide area network. The luminaire locating device may be operative to use the position information of the plurality of luminaires for configuring the luminaires or for commissioning the lighting system.

A system according to an embodiment may comprise a plurality of luminaires, at least three of the luminaires comprising an associated optical sensor and an interface to transmit intensity information captured by the associated optical sensor to a luminaire locating device. The luminaire locating device may comprise an interface to receive the intensity information and an electronic processing device to locate each luminaire of the plurality of luminaires by processing the intensity information captured by the plurality of optical sensors

A method of locating luminaires according to an embodiment comprises receiving, by a luminaire locating device, intensity information captured by a plurality of optical sensors. The method comprises processing, by the luminaire locating device, the received intensity information to locate the luminaires.

Locating the luminaires may include determining two-dimensional position information for plural luminaires. Locating the luminaires may include determining three-dimensional position information for plural luminaires. Locating the luminaires may include determining positions of the luminaires relative to a footprint of a room in which the luminaires are installed.

A luminaire according to an embodiment comprises at least one light emitting diode, an optical sensor to capture intensity information, and an interface to transfer the intensity information for execution of a luminaire self-localization procedure.

A luminaire configuring and commissioning device according to an embodiment comprises a storage medium that stores luminaire address information and luminaire position information for each luminaire of a plurality of luminaires. The luminaire configuring and commissioning device comprises an optical output device to output the luminaire address information of at least one luminaire on an electronic map.

A method of configuring and commissioning luminaires of a lighting system according to an embodiment comprises outputting, via an optical output device, address information for a plurality of luminaires. The method may comprise receiving, at an input interface, information identifying luminaires belonging to a group or light scene. The method may comprise generating, by a processing device, configuring or commissioning information for transmission to a control device of the lighting system.

The devices, systems, and methods according to various embodiments may assist an engineer in commissioning a lighting system. For illustration, locations of various luminaires may be automatically determined. The luminaire locations may be used for controlling an optical output device, which greatly facilitates identifying the various luminaires in accordance with the positions at which they are installed. Alternatively or additionally, luminaires may be provided with an optical sensor that may assist in a self-localization procedure for locating the luminaires.

Additional features of various embodiments and the effects respectively attained thereby will become more apparent from the detailed description of embodiments with reference to the drawings.

### BRIEF DESCRIPTION OF THE DRAWINGS

Embodiments of the invention will be described with reference to the accompanying drawings in which the same or similar reference numerals designate the same or similar elements.

FIG. 1 is a diagram of a system having a luminaire locating device according to an embodiment.

FIG. 2 is a diagram of a system having a luminaire locating device according to an embodiment.

FIG. 3 is a diagram of a system having a luminaire locating device according to an embodiment.

FIG. 4 is a flowchart of a method according to an embodiment.

FIG. 5 is a flowchart of a method according to an embodiment.

FIG. 6 is a diagram of a luminaire locating device according to an embodiment.

FIG. 7 is a diagram of a luminaire locating device according to an embodiment.

FIG. 8 illustrates a process of determining luminaire locations by triangulation techniques employed by a luminaire locating device according to an embodiment.

FIG. 9 illustrates a process of determining luminaire locations by triangulation techniques employed by a luminaire locating device according to an embodiment.

FIG. 10 illustrates a process of determining luminaire locations by comparison with light patterns stored in a database employed by a luminaire locating device according to an embodiment.

FIG. 11 is a flowchart of a method according to an embodiment.

FIG. 12 is a flowchart of a method according to an embodiment.

FIG. 13 is a diagram of a lighting system having a luminaire configuring and commissioning device according to an embodiment.

FIG. 14 is a diagram of a luminaire configuring and commissioning device according to an embodiment.

FIG. 15 is a flowchart of a method according to an embodiment.

### DESCRIPTION OF EMBODIMENTS

Exemplary embodiments of the invention will be described with reference to the drawings. While some embodiments will be described in the context of specific fields of application, e.g. in the context of exemplary techniques of processing captured intensity information to determine luminaire positions, the embodiments are not limited to such techniques. The features of the various embodiments may be combined with each other unless specifically stated otherwise.

Exemplary embodiments of the invention provide techniques of automatically locating luminaires of a lighting system. A luminaire locating device may have an interface at which intensity information captured by a plurality of optical sensors is received. The luminaire locating device may process the received intensity information to locate a plurality of luminaires of the lighting system.

The luminaire locating device may process light color information and/or light modulation to locate the plurality of luminaires.

In order to locate the plurality of luminaires, triangulation techniques, a comparison with light patterns stored in a database, or other processing techniques, such as automatic learning techniques or supervised learning techniques, may be employed.

The luminaire locating device may be a smartphone or another handheld terminal.

The luminaire locating device may have an electronic processing device which may include one or several of a processor, a microprocessor, a controller, a microcontroller, an application specific integrated circuit (ASIC), or other integrated circuits or combinations thereof.

The electronic processing device may be operative to determine two-dimensional or three-dimensional coordinates of the luminaires by triangulation based on the intensity information captured by the plurality of optical sensors.

The electronic processing device may be operative to determine two-dimensional or three-dimensional coordinates of the luminaires by matching the intensity information to intensity patterns stored in a non-transitory storage medium.

The electronic processing device may be operative to determine a position and/or orientation of the luminaire locating device relative to at least one luminaire and/or relative to the room in which the luminaires of the lighting system are installed. The luminaire locating device may comprise at least one sensor coupled to the electronic processing device, the electronic processing device being operative to process an output signal of the at least one sensor to determine the relative position and/or relative orientation. The luminaire locating device may use one or more of an accelerometer, gyro sensor, magnetometer and/or pressure sensor to determine its relative coordinates and orientation. The accelerometer and/or gyro sensor may be used to determine a tilt angle or two tilt angles of the luminaire locating device relative to gravity. The magnetometer may be used for orientation determination. The pressure sensor may be used for relative altitude determination.

The luminaire locating device may be operative to determine the positions of luminaires relative to a footprint of at least one room in which the luminaires are installed. The luminaire locating device may additionally be operative to determine the positions of ambient light sources, such as windows or doors, by processing the received intensity information. The luminaire locating device may be configured to output positions of the luminaires, optionally in combination with positions of windows, doors, of walls, via an optical output device.

The luminaire locating device may be operative to process the intensity information to derive the footprint of the at least one room. Thereby, positions of walls may be automatically determined.

The luminaire locating device may be operative to process the intensity information to derive locations of walls of a room, windows of a room, or floors of the at least one room by processing the intensity information.

The luminaire locating device may have an interface to retrieve the footprint over a wide area network, a local area network, or from a local storage device.

The luminaire locating device may be operative to generate a three-dimensional map including three-dimensional positions of the luminaires by processing the intensity information captured by the plurality of optical sensors.

Each optical sensor of the plurality of optical sensors may be integrated in an associated one of the luminaires. Each luminaire that includes an optical sensor to capture intensity information may be operative to transmit the intensity information over a radio interface or over a wired connection.

The optical sensors may include one or several camera chips. The optical sensors may additionally or alternatively include one or several light sensors capturing light intensity without spatial resolution.

The luminaire locating device may be operative for commissioning the lighting system. The luminaire locating device may have an interface to output information on the determined positions of the luminaires and to receive a user input that assigns the luminaires, based on their positions, to groups or light scenes. The luminaire locating device may be configured to generate a commissioning signal for transmission to the lighting system that includes information on the assignment of luminaires and groups light scenes.

A system according to an embodiment comprises a plurality of luminaires installed in a room. At least three of the luminaires installed in the room comprise respectively an associated optical sensor and an interface to transmit intensity information captured by the associated optical sensor to a luminaire locating device. The luminaire locating device may have an interface at which intensity information captured by a plurality of optical sensors is received. The luminaire locating device may process the received intensity information to locate a plurality of luminaires of the lighting system.

The luminaire locating device or the system according to an embodiment may be used in a method of locating plural luminaires of a lighting system that are installed in a room.

A luminaire according to an embodiment comprises a light emitting diode, an optical sensor to capture intensity information, and an interface to transfer the intensity information for execution of a luminaire self-localization procedure.

The luminaire may comprise a control circuit to control a current supplied to the light emitting diode during the self-localization procedure so as to vary a light intensity output by the luminaire in a time-dependent manner during the self-localization procedure. This allows this luminaire to be more easily distinguished from the light generated by other luminaires in the intensity information captured by sensors of these other luminaires.

The optical sensor may comprise a light sensor. The optical sensor may comprise a camera chip capturing intensity information in a spatially resolved manner.

The results of the luminaire self-localization procedure may be used for configuring luminaires or for commissioning a lighting system.

A luminaire configuring and commissioning device, which may be operative to determine two-dimensional or three-dimensional coordinates of luminaires as described above, may have an interface to receive address information from each luminaire of a plurality of luminaires. The address information may indicate an address assigned to this luminaire in the lighting system.

The luminaire configuring and commissioning device may be operative to generate a table having stored therein the address information for each one of the plurality of luminaires and associated position information for each one of the plurality of luminaires.

The luminaire configuring and commissioning device may have an optical output device to output the luminaire address information of the at least luminaire of the plurality of luminaires on an electronic map.

The optical output device may be operative to output the luminaire address information for each luminaire of the plurality of luminaire installed in a room on the electronic map.

The optical output device may comprise an input interface, which may be attached sensitive or proximity sensitive sensor interface, to enable selection of one or several luminaires in a commissioning procedure.

The luminaire configuring and commissioning device may further comprise a control interface to output a command for configuring or commissioning a lighting system. The command may be generated as a function of the luminaire address information displayed on the electronic map.

The electronic map may show at least one of a room footprint, a floor footprint, or a building footprint.

The above and other features and effects will be described in more detail with reference to the drawings.

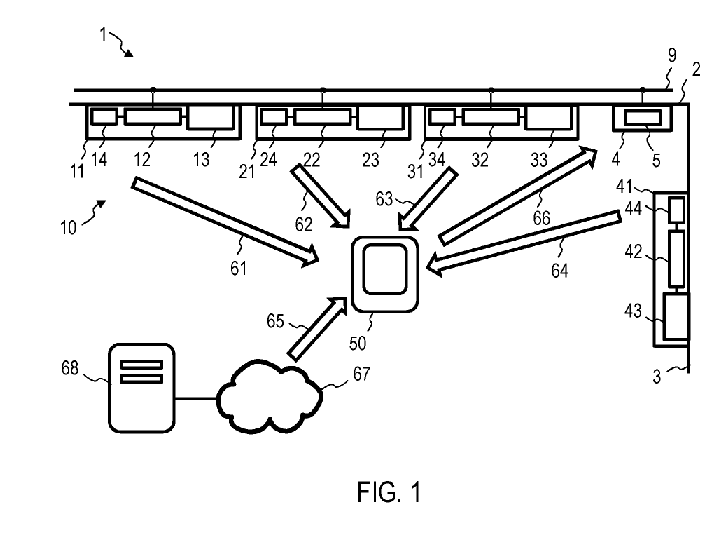

FIG. 1 shows a system 1 according to an embodiment. The system 1 comprises a lighting system 10 and a luminaire locating device 50.

The lighting system 10 comprises a plurality of luminaires 11, 21, 31, 41. The plurality of luminaires 11, 21, 31, 41 may be connected to an electronic power supply 9. The plurality of luminaires 11, 21, 31, 41 may be interfaced with a control device 4. The control device 4 may be operative to control the plurality of luminaires 11, 21, 31, 41. The control device 4 may include an integrated circuit configured to generate commands that include address information of a group of luminaires 11, 21, 31, 41 and which include a dim level, colour level, or other control information for each luminaire in the group of luminaires 11, 21, 31, 41. The commands may be generated as a function of information on groups of luminaires or light scenes involving luminaries. Information on the luminaires that are assigned to groups or light scenes are stored in a non-volatile storage 5. The information on the luminaires that are assigned to groups or light scenes may be written to the storage 5 during commissioning of the lighting system 10.

The luminaires 11, 21, 31, 41 may be installed at a ceiling 2 or a lateral wall 3 of a room.

The luminaire 11 comprises a converter 12 and at least one light emitting diode 13. The luminaire 11 may further comprise an optical sensor 14. The optical sensor 14 may be a light sensor or a camera chip recording intensity information with spatial resolution. The optical sensor 14 may be further operative to detect a color of light and may have a plurality of color channels. The optical sensor 14 may be operative to detect a modulation of the light. The modulation and/or color information may be used for the self-localization of luminaires.

The luminaire 21 comprises a converter 22 and at least one light emitting diode 23. The luminaire 21 may further comprise an optical sensor 24. The optical sensor 24 may be a light sensor or a camera chip recording intensity information with spatial resolution.

The luminaire 31 comprises a converter 32 and at least one light emitting diode 33. The luminaire 31 may further comprise an optical sensor 34. The optical sensor 34 may be a light sensor or a camera chip recording intensity information with spatial resolution.

The luminaire 41 comprises a converter 42 and at least one light emitting diode 43. The luminaire 41 may further comprise an optical sensor 44. The optical sensor 44 may be a light sensor or a camera chip recording intensity information with spatial resolution.

For each one of the luminaires 11, 21, 31, 41, the converter may be operative to provide a current or voltage to the at least one light emitting diode. The at least one light emitting diode may include inorganic or organic light emitting diodes. Different types of light emitting diodes may be provided in different luminaires 11, 21, 31, 41.

The optical sensor 14, 24, 34, 44 may be mounted to a circuit board of a LED module, the converter, or another suitable carrier, e.g. within the shell of a retrofit by.

While four luminaires 11, 21, 31, 41 respectively including an optical sensor 14, 24, 34, 44 are shown in FIG. 1, the techniques described herein may also be used with other numbers of luminaires having an optical sensor provided thereon. For illustration, the techniques described herein may generally be employed with at least three luminaires 11, 21, 31, 41 capturing intensity information. Four or more than four luminaires respectively having an optical sensor may also be used. The lighting system 10 may, and generally will, include also luminaires that do not need to have an optical sensor. As will be described in more detail below, the devices according to embodiments may be operative to determine also the positions of luminaires that do not themselves include an optical sensor.

As will be described in more detail below, the system one is configured such that the locations of the luminaires 11, 21, 31, 41 relative to a room in which they are deployed may be automatically determined. A luminaire locating device 50 may be used in the process of commissioning the lighting system 10 or configuring the individual luminaires 11, 21, 31, 41. The luminaire locating device 50 may be configured to process intensity information captured by the optical sensors 14, 24, 34, 44 in order to automatically determine the locations of the plurality of luminaires 11, 21, 31, 41 relative to the room in which they are installed. The luminaire locating device 50 may be configured to process color information and/or modulation intensity information captured by the optical sensors 14, 24, 34, 44 in order to automatically determine the locations of the plurality of luminaires 11, 21, 31, 41 relative to the room in which they are installed. The modulation information may be derived from intensity. The color information may include intensity information for each one of several color channels.

To this end, the luminaires 11, 21, 31, 41 may be controlled such that the different luminaires output different light levels and/or different colors in a time-sequential manner. The luminaire locating device 50 may interact with the control device 4 in order to cause different luminaires to be operated with different dim levels, color settings and/or modulation schemes in a time-sequential manner during the procedure of automatically locating the luminaires.

The optical sensors 14, 24, 34, 44 may respectively capture intensity information for each one of the different sets of light levels. The intensity information may be transmitted to the luminaire locating device 50, e.g. in radio signals 61, 62, 63, 64. The luminaires 11, 21, 31, 41 may respectively have a radio interface for transmitting the intensity information to the luminaire locating device 50.

The luminaire locating device 50 may have a wireless interface to receive the intensity information from the luminaires 11, 21, 31, 41. The wireless interface may be operative for a near field communication technique, Bluetooth, ZigBee, Wi-Fi, 3GPP machine-to-machine (M2M), or other cellular or non-cellular communication techniques.

The luminaire locating device 50 may have at least one processor, controller, ASIC or other integrated circuit or a combination of such circuits to process the intensity information received from the luminaires 11, 21, 31, 41. The luminaire locating device 50 may be operative to process the intensity information, which may include a plurality of successively captured intensity values from each one of the plurality of optical sensors 14, 24, 34, 44, to determine the locations of the luminaires 11, 21, 31, 41 relative to the room in which they are installed.

Various techniques such as triangulation based techniques, automatic learning techniques, supervised learning techniques, or pattern recognition techniques may be employed by the luminaire locating device 50.

Locating the luminaires may include determining at least three coordinates of each one of the luminaires 11, 21, 31, 41 installed in the room and connected to the control device 4. Locating the luminaires may include determining coordinates that indicate the x-, y-, and height coordinates of each one of plural luminaires 11, 21, 31, 41.

The luminaire locating device 50 may retrieve additional information for assistance in the process of locating the luminaires. For illustration, a footprint of the room in which the luminaires are installed may be retrieved from a server 68 over a wide area network 67. The luminaire locating device 50 may communicate with the server 68 over the wide area network 67 to retrieve the footprint in a signal 65.

The luminaire locating device 50 may be operative to process the output signals of the optical sensors 14, 24, 34, 44 to determine locations of windows or doorways, for example. Alternatively or additionally, the luminaire locating device 50 may be operative to process the output signals of the optical sensors 14, 24, 34, 44 to automatically determine the footprint of the room in which the luminaires 11, 21, 31, 41 are installed.

The locations of luminaires determined by the luminaire locating device 50 may be used in various ways. For illustration, the positions of the various luminaires in association with address information for the respective luminaire may be transmitted to the control device 4 for subsequent use. Alternatively or additionally, the luminaire locating device 50 may transmit a commissioning signal 66 to the control device for in which the various luminaires are assigned to groups or light scenes. The luminaire locating device 50 may use the position information determined for the plurality of luminaires 11, 21, 31, 41 in order to assist an engineer in assigning luminaires to groups or light scenes. More specifically, the luminaire locating device 50 may generate graphics which indicate the luminaires or luminaire address information in association with the positions at which the luminaires 11, 21, 31, 41 are installed. The luminaires or luminaire address information may be displayed on an electronic map. A footprint of the room in which the luminaires are installed and, optionally, locations of windows or doorways may also be displayed to assist the engineer in assigning luminaires to groups or light scenes.

In response to a user input received at the luminaire locating device 50, luminaire locating device 50 may generate a commissioning signal 66 for transmission to the control device 4. The commissioning signal 66 may include information on which luminaires 11, 21, 31, 41 are respectively assigned to each one of plural groups of luminaires and/or are respectively assigned to each one of plural light scenes.

Alternatively or additionally, the luminaire locating device 50 may be operative to transmit a configuration signal to at least a subset of the luminaires 11, 21, 31, 41 to configure the luminaires in configuring the lighting system 10.

The commissioning signal 66 and/or the configuration signal may respectively be generated as a function of a user input that is received by the luminaire locating device 50 when graphics are output that indicate the locations of the luminaires 11, 21, 31, 41 in the room in which they are installed. The commissioning may be even performed off-site and in dependence on automatically determined luminaire locations.

Generally, and as will be described more detail below, a plurality of luminaires 11, 21, 31, 41 which respectively include at least one optical sensor 14, 24, 34, 44 may be used for an automatic self-localization procedure of the luminaires. The optical sensors 14, 24, 34, 44 may be installed in retrofit bulbs, LED modules, or other light emitting units that include at least one light emitting diode. The optical sensors 14, 24, 34, 44 may include at least one optical sensor that is operative to capture a light intensity without having any spatial resolution.

One or several of the luminaires may respectively include a plurality of light sensors directed so as to capture the light intensity for a plurality of different directions, to thereby provide at least some degree of spatial resolution.

One or several of the luminaires may respectively include an optical sensor that is a camera chip to capture the light intensity with spatial resolution. The light intensity captured by the optical sensors, be with or without spatial resolution, may be transmitted for processing.

While the luminaires 11, 21, 31, 41 may respectively have an interface that may be a radio interface for communication with a luminaire locating device 50, the luminaires 11, 21, 31, 41 do not need to be operative to directly communicate with the luminaire locating device 50. For illustration, the luminaires 11, 21, 31, 41 may be operative to transmit the intensity information that was respectively captured by the optical sensors 14, 24, 34, 44 to the control device 4. Wired or wireless transmission techniques may be used. The control device 4 may transmit the intensity information to the luminaire locating device 54 for automatically determining the positions of the luminaires 11, 21, 31, 41 in two or three dimensions.

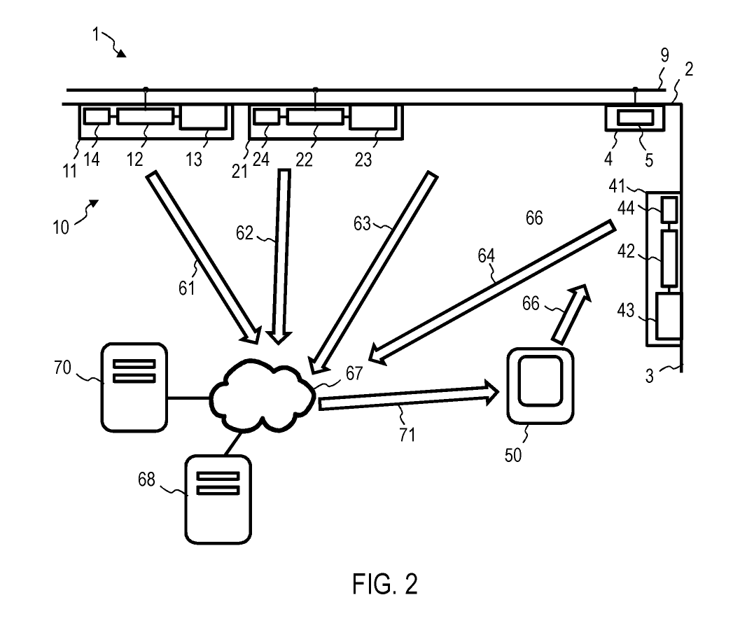

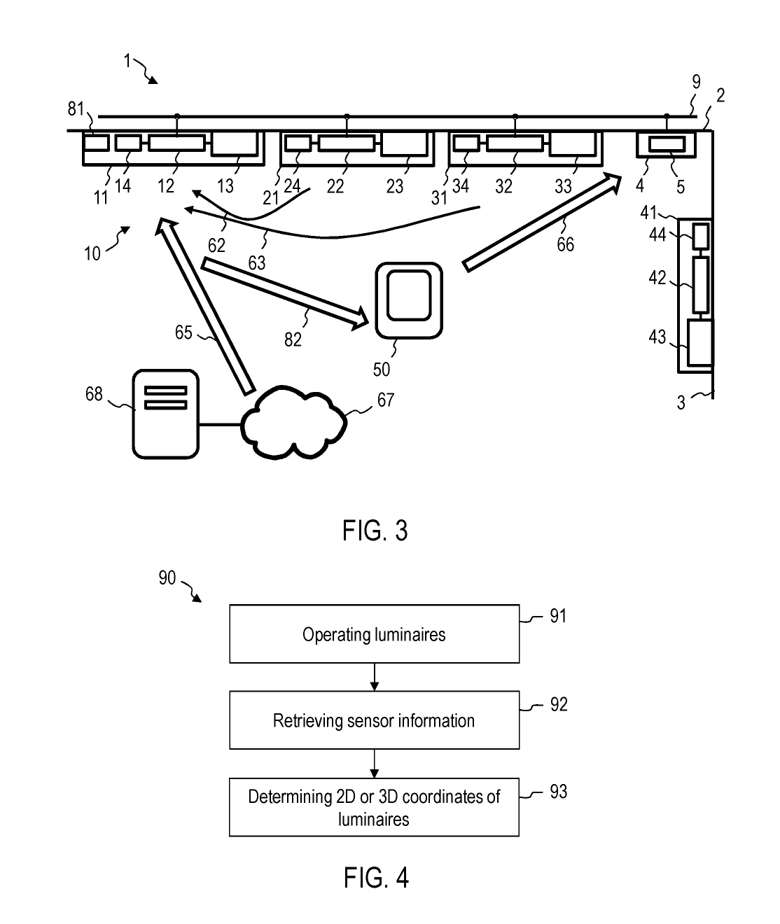

While the luminaire locating procedure may be carried out by a luminaire locating device that is a handheld device 50, other implementations may be used in further embodiments, as will be exemplarily described with reference to FIG. 2 and FIG. 3.

FIG. 2 is a diagram of a system 1 according to an embodiment. Elements and units that correspond with respect to their configuration and/or operation to elements or devices that have already been described with reference to FIG. 1 are designated with the same reference numerals as in FIG. 1.

In the system 1 of FIG. 2, the luminaire locating device is a server 70 that may be coupled to a wide area network 67. The luminaires 11, 21, 31, 41 respectively including an optical sensor 14, 24, 31, 44 for a localization procedure may be operative to output intensity information for transmission to the luminaire locating device implemented by the server 70. The server 70 acting as the luminaire locating device may be operative to perform any one of the procedures described with reference to FIG. 1. For illustration, the server 70 may determine two-dimensional or three-dimensional coordinates of the luminaires 11, 21, 31, 41 in dependence on the intensity information reported by the luminaires 11, 21, 31, 41 for respectively each one of a plurality of different dim levels to which the luminaires 11, 21, 31, 41 are set in order for the data acquisition to be performed in the self-localization.

The server 70 may perform triangulation procedures or may compare captured light patterns to a database of light patterns in order to determine two-dimensional or three-dimensional coordinates of the luminaires and, optionally, a footprint of the room and/or locations of windows and/or doorways.

The server 70 may interact with at least one further server 68 over the wide area network 67 to retrieve additional information on the room in which the luminaires 11, 21, 31, 41 are installed. For illustration, the additional information may include a building footprint or a floor plan of the building in which the luminaires 11, 21, 31, 41 are installed. The server 70 may retrieve information on light distribution patterns and respectively associated locations of luminaires from a database stored in the server 68.

The server 70 may transmit location information 71 to a handheld commissioning device 50. The location information 71 may include two-dimensional or three-dimensional position information for each luminaire of the plurality of luminaires 11, 21, 31, 41 of the lighting system 10 installed in the room.

The handheld commissioning device 50 may have a graphical user interface to output position information for the plurality of luminaires, for example on an electronic map. The handheld commissioning device 50 may allow an engineer to assign the luminaires shown on the graphical output interface of the handheld commissioning device 50 to groups or light scenes. The handheld commissioning device 50 may generate a commissioning signal 66 for transmission to the control device 4. The commissioning signal 66 may include information on which luminaires are assigned to which one of plural groups or plural light scenes. This information included in the commissioning signal 66 may be stored at the control device 4 in a non-volatile manner, optionally after further processing.

In the system 1 of FIG. 2, the functions of the luminaire locating device and of inputting the relevant data for commissioning may be performed by separate entities, i.e. by the server 70 which is the luminaire locating device and the handheld device 50 which uses the determined two- or three-dimensional positions of the luminaires for assisting an engineer in the commissioning task.

Alternatively or additionally to determining luminaire positions at the server 70 or at the handheld device 50, the self-localization may also be implemented by an integrated circuit that may be installed in one of the luminaires 11, 21, 31, 41 or in the control device 4. Such a system will be explained in more detail with reference to FIG. 3.

FIG. 3 is a diagram of a system 1 according to an embodiment. Elements and units that correspond with respect to their configuration and/or operation to elements or devices that have already been described with reference to in FIG. 1 and FIG. 2 are designated with the same reference numerals as in FIG. 1 and FIG. 2.

The system 1 of FIG. 3 includes a lighting system 10 having a plurality of luminaires 11, 21, 31, 41 and a control device 4. At least one of the luminaires 11 may include at least one integrated circuit 80 operative to determine two-dimensional or three-dimensional coordinates of the luminaires 11, 21, 31, 41 by processing the intensity information captured by the optical sensors 14, 24, 34, 44 installed in luminaires.

The at least one integrated circuit 80 may be operative to receive intensity information 62, 63 from at least two further luminaires 21, 31. The intensity information may represent intensity captured by the optical sensors 24, 34 of the at least two further luminaires 21, 31.

The at least one integrated circuit 80 may perform triangulation procedures or may compare reported light patterns to a database of light patterns in order to determine two-dimensional or three-dimensional coordinates of the luminaires and, optionally, a footprint of the room and/or locations of windows and/or doorways.

The at least one integrated circuit 80 may interact with a server 68 over the wide area network 67 to retrieve additional information on the room in which the luminaires 11, 21, 31, 41 are installed. For illustration, the additional information may include a building footprint or a floorplan of the building in which the luminaires 11, 21, 31, 41 are installed. The at least one integrated circuit 80 may retrieve information on light distribution patterns and respectively associated locations of luminaires from a database stored in the server 68.

The at least one integrated circuit 80 may transmit luminaire location information 81 to a handheld commissioning device 50. The luminaire location information 81 may include two-dimensional or three-dimensional position information for each luminaire of the plurality of luminaires 11, 21, 31, 41 installed in the room.

The handheld commissioning device 50 may have a graphical user interface to output position information for the plurality of luminaires, for example on an electronic map. The handheld commissioning device 50 may allow an engineer to assign the luminaires shown on the graphical output interface of the handheld commissioning device 50 to groups or light scenes. The handheld commissioning device 50 may generate a commissioning signal 66 for transmission to the control device 4. The commissioning signal 66 may include information on which luminaires are assigned to which one of plural groups or plural light scenes. This information included in the commissioning signal 66 may be stored at the control device for in a non-volatile manner, optionally after further processing.

While the luminaire locating device may be implemented in a handheld commissioning device, in a server connected to a lighting system over a wide area network, or in a component of the lighting system 10, other configurations may be used in still other embodiments.

In any one of the various embodiments, the luminaire locating device may perform a triangulation based on the captured intensity information, a comparison with a database of lighting patterns, or other processing to determine the two-dimensional or three-dimensional positions of the luminaires 11, 21, 31, 41 from the captured intensity information. In any one of the various embodiments, the luminaire locating device may use additional information such as a room footprint or floorplan that may be retrieved over a wide area network to assist in the self-localization procedure.

Techniques that may be performed by the luminaire locating device according to an embodiment will be described in more detail with reference to FIG. 4 to FIG. 15 below.

FIG. 4 is a flowchart of a method 90 according to an embodiment. The method 90 may be performed by a luminaire locating device or a lighting system 10 according to an embodiment.

At 91, each luminaire installed in a room may be operated in a self-localization procedure in which positions of the luminaires installed in the room are automatically determined. The various luminaires may be operated consecutively. For illustration, during the self-localization, each one of plural luminaires may be operated to output light in at least one or several different dim levels, while the optical sensors 14, 24, 34, 44 capture intensity information that result from the activation of the respective luminaire. The intensity information captured by the optical sensors 14, 24, 34, 44 may be processed further to determine the position of the luminaire that was activated to output light.

The process of activating a luminaire may be repeated consecutively for each one of the different luminaires installed in the room.

By operating the luminaires such that each luminaire outputs light in at least two different dim levels, an influence of ambient sources such as sunlight may be mitigated. The luminaire locating device may be operative to discriminate light intensity that stems from the light output by the luminaire and light intensity that stems from ambient sources different from the luminaire. Additionally or alternatively, the light output of the luminaire may be modulated in a specific time varying manner, in order to allow the luminaire locating device to discriminate the light provided by the luminaire from ambient light sources when processing the outputs of the optical sensors 14, 24, 34, 44.

While luminaires may be activated in a time-sequential manner such that only one of the luminaires outputs light at any time, it is also possible that several luminaires are operated to simultaneously output light. The dim levels may be adjusted so as to vary the relative light flux of one luminaire relative to another one of the luminaires. The influence of the light output by different luminaires on the overall intensity captured by the optical sensors 14, 24, 34, 44 may then be determined in processing the intensity information.

At 92, the luminaire locating device may retrieve the intensity information captured by the optical sensors. The intensity information may include a single value captured by a sensor and indicating a light intensity received by the sensor, respectively for each one of the various dim levels in which the luminaires were operated at 91. The optical sensors may have more complex configurations and may be operative to capture intensity information with spatial resolution. For illustration, one, several, or each one of the optical sensors 14, 24, 34, 44 may be a camera chip operative to capture intensity information in a spatially resolved manner.

The intensity information may be transmitted by the optical sensors 14, 24, 34, 44 or the luminaires in which they are installed over a wired or wireless connections. For illustration, radio communication links may be established between the luminaire locating device and the luminaires in order to retrieve the intensity information captured by the optical sensors 14, 24, 34, 44 during the self-localization procedure.

At 93, the intensity information may be processed to determine locations of the luminaires. The processing at 93 may be performed based on additional information that may be stored locally at the luminaire locating device or that may be retrieved by the luminaire locating device over a wide area network. For illustration, the luminaire locating device may be operative to retrieve a floor plan or a building plan from a database over a wide area network to determine the footprint of the room in which the luminaires are installed. The position of the luminaire locating device may be automatically determined, e.g. using GPS or other automatic positioning techniques, to determine in which building the luminaires are installed.

The determining at 93 may include determining two-dimensional or three-dimensional coordinates of luminaires. The two-dimensional coordinates may include x- and y-coordinates of each one of the luminaires of the lighting system 10 installed in the room. The three-dimensional coordinates may include height coordinates in addition to the x- and y-coordinates. This may be particularly helpful when at least some of the luminaires are installed on lateral side walls rather than the ceiling of the room. Similarly, height information may be particularly helpful when at least some of the luminaires are installed as floor lights rather than on the ceiling.

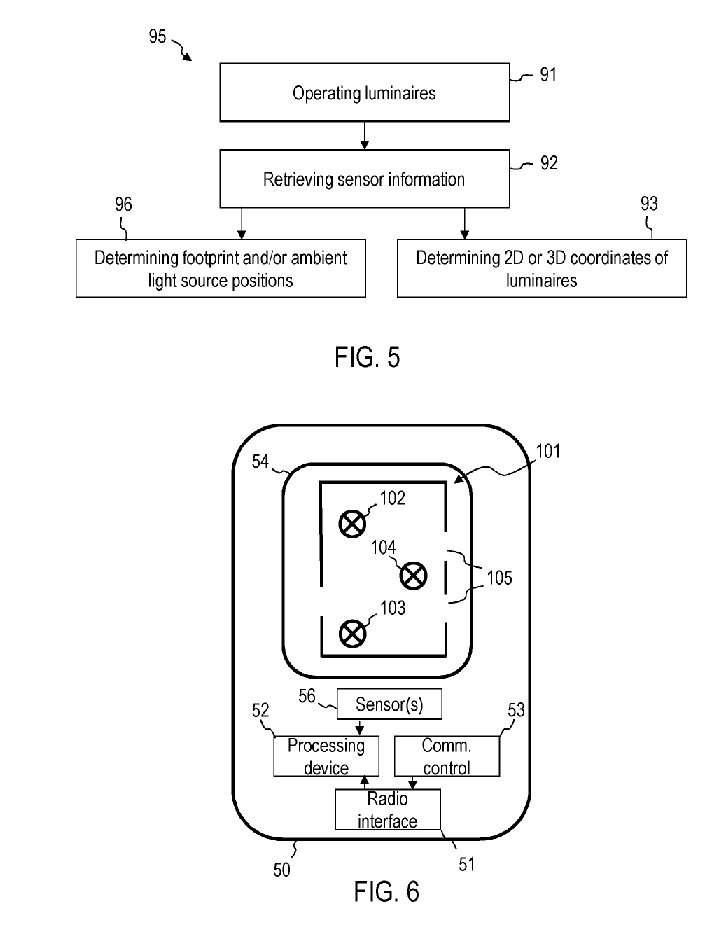

FIG. 5 is a flowchart of a method 95 according to an embodiment. The method 95 may be performed by a luminaire locating device or a lighting system 10 according to an embodiment.

In the method 95, step 91 of operating the luminaires during the self-localization procedure is, step 92 of retrieving the sense information by a luminaire locating device, and step 93 of determining two-dimensional or three-dimensional coordinates of luminaires may be performed as described with reference to FIG. 4.

Additionally, at 96, the intensity information may be processed to determine a footprint of the room in which the luminaires are installed or positions of windows or doorways from the captured intensity information. Information on windows or doorways may be obtained from the intensity information recorded by the optical sensors 14, 24, 34, 44 that is independent of the light output of the luminaires 11, 21, 31, 41.

The footprint of the room may be determined based on light scattering or reflections that are captured by the optical sensors 14, 24, 34, 44.

FIG. 6 is a diagram of a luminaire locating device implemented as a handheld device 50 that is also operative to commission the lighting system 10. The handheld device 50 may be implemented as a smartphone, a portable computer, or another electronic device that executes instructions for performing a luminaire locating procedure.

The handheld device 50 comprises a radio interface 51. The radio interface 51 may be operative to receive intensity information captured by a plurality of optical sensors 14, 24, 34, 44 that are installed in luminaires in a room. The radio interface 51 may optionally be operative to retrieve additional information such as a building footprint, a floor plan, or other data over a wide area network.

The handheld device 50 comprises a processing device 52. The processing device 52 may include one or several integrated circuits. The one or several integrated circuits may comprise at least one processor, at least one microprocessor, at least one controller, at least one microcontroller, at least one application specific integrated circuit (ASIC), or a combination of such or other integrated circuits. The processing device 52 may be operative to process the received intensity information captured by the optical sensors 14, 24, 34, 44. The processing device 52 may be operative to determine two-dimensional or three-dimensional coordinates of the luminaires installed in the room. The processing device 52 may be operative to determine the positions of the luminaires by triangulation based on the received intensity information. The processing device 52 may additionally or alternatively be operative to determine the positions of the luminaires by comparing the captured intensity information with intensity patterns stored in a database.

The handheld device 50 may comprise an optical output device 54. The optical output device 54 may be implemented as a graphical user interface that also may include input interface elements such as capacitive touch or proximity sensing elements, resistive touch or proximity sensing elements, or other touch or proximity sensing elements.

The processing device 52 may be operative to control the optical output device 54 such that a map 101 of the room in which the luminaires are installed is shown. The method 101 may be an electronic map that includes the information on the two-dimensional or three-dimensional positions of the luminaires. For illustration, graphical representations indicating the luminaires 102-104 may be displayed on the electronic map at the positions that correspond to the respective luminaire positions. The position of the handheld device 50 may optionally also be included. The position of the handheld device 50 in the room may be determined by known positioning techniques, e.g. by image processing of images captured by a camera of the handheld device 50. The electronic map 101 may include information on the room in which the luminaires are installed. The information on the room may include footprint of the room in which the luminaires are installed. The information on the room may include information on the positions at 105 of windows or doorways.

As will be described in more detail below, address information for the various luminaires in the lighting system may also be displayed on the graphical output device 54.

The handheld device 50 may be operative to receive a user input. The user input may assign various luminaires to one or several groups or light scenes. For illustration, an engineer commissioning the lighting system may indicate which ones of the luminaires displayed on the electronic map 101 along to the same group or to the same light scene. The handheld device 50 may evaluate the user input. The handheld device 50 may generate a table or other data structure that indicates, for each one of several groups or light scenes, which luminaires of the plurality of luminaires installed in the room are associated with the respective group or light scene.

The handheld device 50 may include a commissioning controller 53. The commissioning controller 53 may be operative to generate a commissioning signal for transmission to the control device 4 of the lighting system 10. The commissioning controller 53 may be operative to generate the commissioning signal such that it includes information that indicates which luminaires installed in the room belonged to which one of several groups or light scenes that may be defined by a user input at the handheld device 50.

The handheld device 50 may be operative to determine a position and/or orientation of the handheld device 50 relative to at least one luminaire and/or relative to the room in which the luminaires of the lighting system are installed. The handheld device 50 may comprise at least one sensor 50 coupled to the electronic processing device 52. The electronic processing device 52 may be operative to process an output signal of the at least one sensor 55 to determine the relative position and/or relative orientation. The handheld device 50 may use one or more of an accelerometer, gyro sensor, magnetometer and/or pressure sensor to determine its relative coordinates and orientation. The accelerometer and/or gyro sensor may be used to determine a tilt angle of the handheld device 50 relative to gravity. The magnetometer may be used for orientation determination, e.g. to determine a second angle that defines the orientation of the handheld device 50 in a plane transverse to the gravity vector. The pressure sensor may be used for relative altitude determination. Pressure sensors may be operative to determine an altitude with a resolution of 2 m, 1 m, or with even greater specificity, which allows the handheld device 50 to determine in which floor of a building the handheld device 50 is located based on the output signal of a pressure sensor.

The radio interface 51 may be operative to transmit a commissioning signal to a control device 4 of the lighting system 10.

While the commissioning may be performed using the handheld device 50 which may be used on site, the commissioning may also be performed using a tool that is executed remotely from the lighting system 10. For illustration, an application executed on a server connected to a wide area network may allow an engineer to assign luminaires to groups or light scenes while allowing the engineer to be remote from the lighting system 10. The commissioning signal may be transmitted to the control device for using wide area network transmission techniques. For illustration, referring to the system of FIG. 2, the commissioning may be performed by an application that is executed on the server 70.

While the function of determining two-dimensional or three-dimensional luminaire positions may be performed by the commissioning device, the function of locating luminaires and of commissioning the lighting system may also be performed by separate devices. The luminaire locating device main this case provide information on the two-dimensional or three-dimensional luminaire positions to the commissioning device.

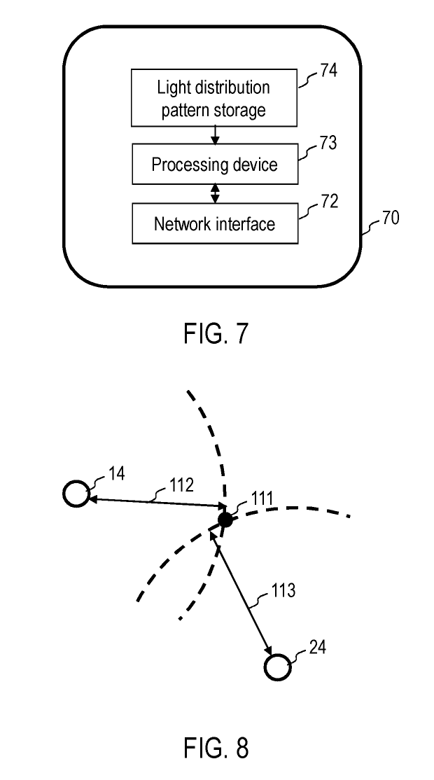

FIG. 7 is a block diagram of a luminaire locating device that may be implemented as a server 70. The luminaire locating device may be operative to receive intensity information captured by optical sensors 14, 24, 34, 44 over a network interface 72. The network interface 72 may be configured for coupling to a wide area network, such as the internet.

The server 70 which operates as luminaire locating device may comprise a processing device 73. The processing device 73 may include one or several integrated circuits. The one or several integrated circuits may comprise at least one processor, at least one microprocessor, at least one controller, at least one microcontroller, at least one application specific integrated circuit (ASIC), or a combination of such or other integrated circuits.

The processing device 73 may be operative to process the received intensity information captured by the optical sensors 14, 24, 34, 44. The processing device 73 may be operative to determine two-dimensional or three-dimensional coordinates of the luminaires. The processing device 73 may be operative to determine the positions of the luminaires by comparing the captured intensity information with intensity patterns stored in a database. The server 70 may comprise a storage medium 74 for non-volatile storage of light distribution patterns and associated luminaire position information. The processing device 73 may be operative to retrieve light patterns stored in the storage medium 74 for comparing the captured intensity information as reflected by the sensor outputs of the optical sensors 14, 24, 34, 44 with the light patterns stored in the storage medium 74. Based on the best match, the two-dimensional or three-dimensional positions of luminaires may be determined from the luminaire coordinates stored for the best match pattern in the storage medium 74. The processing device 73 may alternatively or additionally be operative to determine the positions of the luminaires by triangulation based on the received intensity information.

The processing device 73 may also be operative to determine characteristics of the room in which the luminaires are installed by processing the intensity information. The processing device 73 may be operative to determine a footprint of the room and/or positions of windows or doorways. Images captured by at least one of the optical sensors 14, 24, 34, 44 implemented as a small camera chip may be evaluated to determine the footprint and, optionally, locations of windows or doorways in the room.

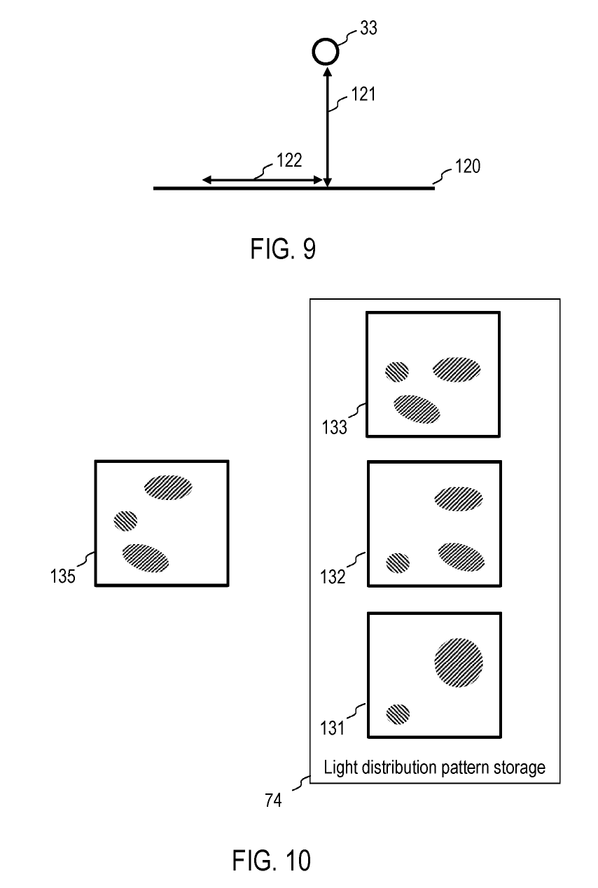

Irrespective of whether the luminaire locating device is implemented in a handheld device, a server connected to a wide area network, or a device of the lighting system, various different techniques may be employed to determine the two-dimensional or three-dimensional coordinates of the luminaires. For illustration, triangulation techniques may be employed as will be described in more detail with reference to FIG. 8 and FIG. 9. Alternatively or additionally, a comparison may be made to light patterns stored in a database to identify the best match and to determine the positions of luminaires based on the best match as will be described in more detail with reference to FIG. 10. Alternatively or additionally, simulation techniques may be used in which the expected distribution of light intensity is simulated for a plurality of hypothetical distributions of luminaire positions. The positions of the luminaires may be adjusted in the simulation until a match is attained with the captured intensity information for each one of the different light outputs to which the luminaires are set in the self-localization procedure.

FIG. 8 is a diagram illustrating operation of a luminaire locating device based on triangulation techniques.

To optical sensors 14, 24 and a third optical sensor (not shown in FIG. 8) may capture intensity information when a luminaire outputs light. The relative magnitude of the intensity captured by the optical sensors 14, 24 determines the ratio of a first radius 112 in which the light source is positioned around the first optical sensor 14 and a second radius 113 in which the light source is positioned around the second optical sensor 24. The position of the light source 111 can be determined by processing the intensity information. It will be appreciated that the output of the third optical sensor may allow the position determining accuracy to be improved for two dimensions are may optionally allow the position of the light source to be determined even in three dimensions, i.e. including a height coordinate.

Even greater numbers of sensors may be used, such as four optical sensors installed in luminaires. By using greater numbers of sensors, the accuracy with which luminaire positions may be automatically determined may be increased.

FIG. 9 is a diagram illustrating operation of a luminaire locating device based on triangulation techniques.

A light emitting means 33 of a luminaire 31 may be installed at a ceiling of a room at a height 121 above floor 120. The distribution of the light intensity on the floor 120 may be determined not only by the distance 122 from the projection point of the light emitting means 33 onto the floor 120, but will also depend on their height 121 at which the light emitting means 33 is installed above the floor 120. The characteristic variation in light intensity as a function of radial distance 122 may be evaluated by the luminaire locating device to derive the height 121. Thereby, the height coordinate of the luminaire may be determined.

FIG. 10 is a diagram illustrating operation of a luminaire locating device based on a comparison with a database of light distribution patterns.

A storage medium 74, which may be a storage medium of the luminaire locating device or which may be provided separately from the luminaire locating device, has stored therein a plurality of light distribution patterns 131-133. The storage medium 74 may have further stored information on the number and the two-dimensional or three-dimensional positions of the luminaires that has given rise to each one of the light distribution patterns 131-133.

The luminaire locating device may be operative to compare the light distribution pattern 135 that was captured by a plurality of optical sensors, at least some of which are installed in luminaires, to the plurality of light distribution patterns 131-133 stored in the storage medium 74. The coordinates of the luminaires that are associated with the one of the light distribution patterns 133 that provides the best match to the recorded light distribution pattern 135 may define the luminaire coordinates.

Different metrics may be used to compare the captured light distribution pattern 135 to each one of the plurality of light distribution patterns 131-133 stored in the storage medium 74. For illustration, a sum of squares of pixel-wise intensity differences or other metric distances between images may be employed to identify the best match.

Simulation techniques may be employed in addition or as an alternative to triangulation and pattern matching with predefined light distribution patterns of a database. For illustration, the light distribution expected for a given set of positions of luminaires may be computed by simulation techniques. The light distribution may be compared to the actually captured light distribution. This may be performed for each one of plural different intensity levels at which the various luminaires are operated. A best match may be determined at which the actually measured light distribution is in optimum agreement with the simulated results for each one of plural different dim levels to which the luminaires are set in the self-localization procedure.

The results of a triangulation-based luminaire position estimation or the results of a comparison with light distribution patterns stored in the database may be used as initial estimate for luminaire positions, which may then be refined using simulation techniques or other procedures.

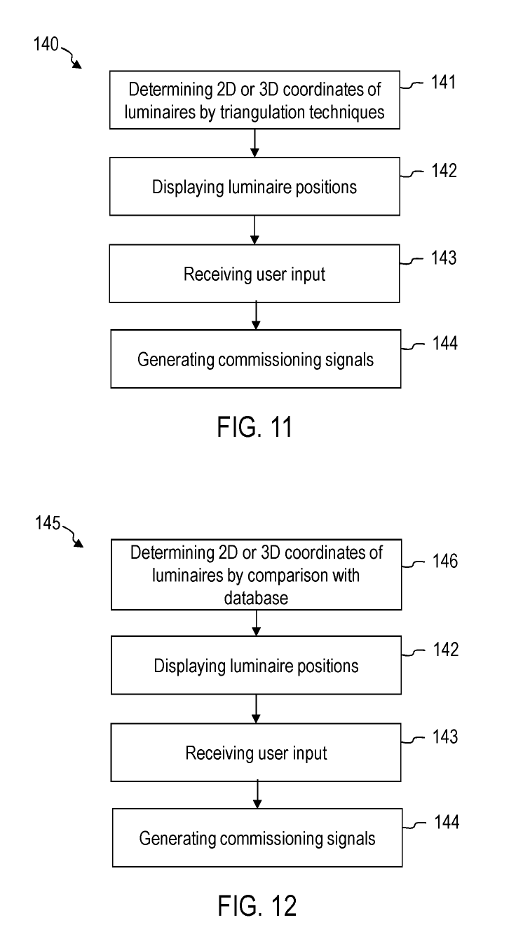

The results of the luminaire localization may be employed in commissioning a lighting system and, optionally, configuring luminaires. FIG. 11 and FIG. 12 illustrate exemplary methods according to embodiments that may be performed using the luminaire locating devices and methods according to embodiments.

FIG. 11 is a flowchart of a method 140 according to an embodiment. The method 140 may be performed by the luminaire locating device according to an embodiment. The method 140 may be performed in combination by the luminaire locating device according to an embodiment and a commissioning device that is separate from the luminaire locating device.

At 141, two-dimensional or three-dimensional coordinates of luminaires may be determined by triangulation techniques. The triangulation may be performed as exemplarily described with reference to FIG. 8 and FIG. 9. In addition to triangulation techniques, numerical simulations may be employed.

At 142, the luminaire positions may be displayed. The luminaire positions may be displayed on an electronic map that is output by a graphical user interface. Displaying the luminaire positions may include displaying the luminaires at positions relative to a footprint of a room in which the luminaires are installed. Windows and doorways of the room may optionally also be displayed. Displaying the luminaires may optionally include displaying addresses of each luminaire on the electronic map.

The displayed addresses of each luminaire may be addresses assigned to the luminaires in the lighting system. It should be appreciated that those addresses that are assigned to the luminaires by the control device 4, for example, do typically not correspond to positions in an intuitive manner. Displaying these addresses assigned to the luminaires in the lighting system may therefore be particularly beneficial in assisting an engineer in configuring or commissioning the lighting system.

At 143, a user input may be received. The user input may be received on a graphical user interface at which the luminaire positions are displayed on an electronic map. The user input may assign luminaires to one or several groups or light scenes. The information assigning luminaires to one or several groups or light scenes may be stored for transmittal to the control device 4 of the lighting system 10.

At 144, a commissioning signal may be generated which carries data assigning the luminaires to one or several groups or light scenes. The data may be generated based on the input received when the electronic map with the luminaire positions shown thereon was output. The data may be transmitted over a radio communication link or over a wired connection to the control device 4 of the lighting system 10. The assignment of luminaires to groups or light scenes may be stored in a non-volatile manner in a memory 5 of the control device 4.

FIG. 11 is a flowchart of a method 145 according to an embodiment. The method 145 may be performed by the luminaire locating device according to an embodiment. The method 145 may be performed in combination by the luminaire locating device according to an embodiment and a commissioning device that is separate from the luminaire locating device.

At 146, two-dimensional or three-dimensional coordinates of luminaires may be determined by comparing a light pattern detected by the optical sensors 14, 24, 34, 44 of luminaires with a set of light patterns. The set of light patterns may be stored in a database, respectively with associated position information for the plurality of luminaires. Alternatively or additionally, simulation techniques may be used to simulate the expected light distribution for a given set of luminaire coordinates, with the captured light pattern then being compared to the results of the simulation to determine which set of luminaire coordinates provides the best match to the detected light pattern. The comparison of light patterns to predefined or simulated light patterns may be performed as exemplarily described with reference to FIG. 10.

The results of the luminaire locating procedure may subsequently be used to assist an engineer in assigning luminaires to groups or light scenes for commissioning the lighting system. Steps 142, 143, 144 may be performed as explained with reference to FIG. 11.

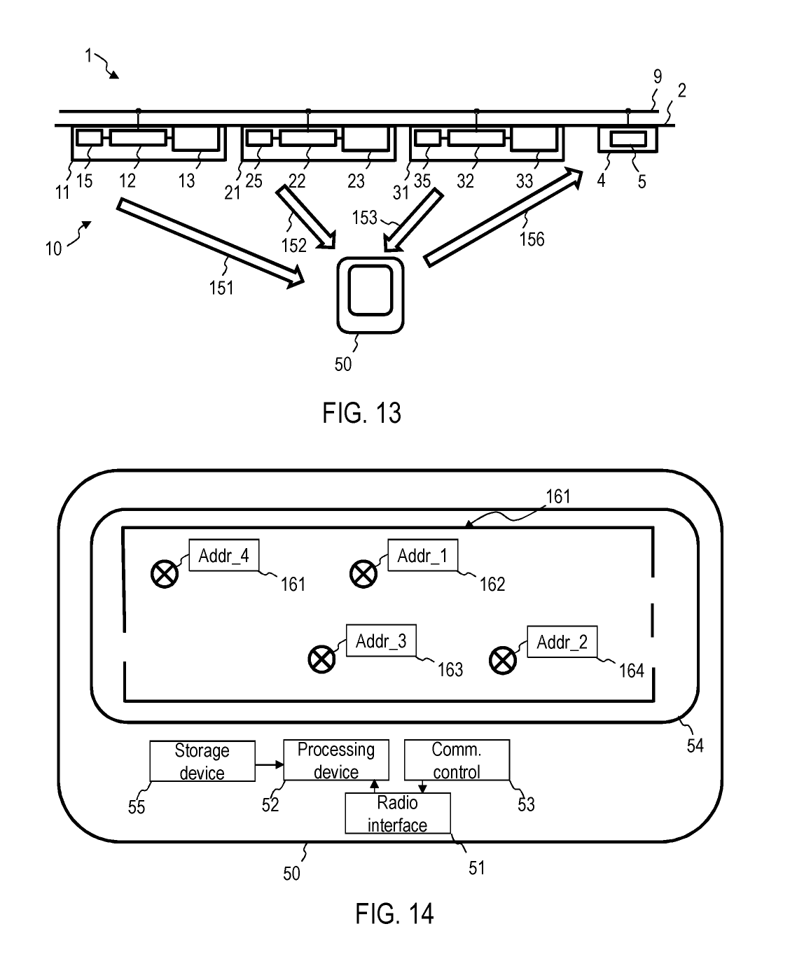

A luminaire configuring and commissioning device according to an embodiment and commissioning methods will be explained in more detail with reference to FIG. 13 to FIG. 15. While the luminaire configuring and commissioning device 50 may be operative to perform the luminaire locating procedure described with reference to FIG. 1 to FIG. 12, the luminaire configuring and commissioning device 50 does not need to be operative to determine luminaire coordinates itself. Further, when the luminaire configuring and commissioning device 50 is operative to determine the luminaire coordinates, the luminaire configuring and commissioning device 50 may employ techniques other than the ones described with reference to FIG. 1 to FIG. 12 above.

FIG. 13 is a diagram of a system one according to an embodiment. The system 1 comprises a lighting system 10 that may be installed in a room having a ceiling 2. The system 1 further comprises a luminaire configuring and commissioning device 50.

As will be described in more detail below, the luminaire configuring and commissioning device 50 may have a storage device to store a database of luminaire positions and associated address information of the luminaires in the lighting system 10. The luminaire positions may be autonomously determined by the luminaire configuring and commissioning device 50 using any one of the techniques described with reference to FIG. 1 to FIG. 12. Alternatively or additionally, the luminaire positions may be determined by other devices or may even be input by a user.

The luminaire configuring and commissioning device 50 may be operative to associate luminaire addresses and luminaire positions. To this end, a plurality of luminaires 11, 21, 31 of the lighting system 10 may each have a transmitter 15, 25, 35. The transmitter 15, 25, 35 may respectively be a radio transmitter, an optical transmitter, or another transmitter. The transmitter 15, 25, 35 may be respectively operative to transmit the address that is assigned to the respective luminaire 11, 21, 31 in the lighting system 10 to the luminaire configuring and commissioning device 50. The luminaire configuring and commissioning device 50 may be operative to assign the received address information to one of the luminaire positions that may have been determined using any one of the tin techniques described with reference to FIG. 1 to FIG. 12 or any other luminaire locating technique.

For illustration, the luminaire configuring and commissioning device 50 may be operative to respectively determine the position of the luminaire configuring and commissioning device 50, using GPS, image evaluation based on an image captured with a camera of the luminaire configuring and commissioning device 50, or other positioning techniques. The luminaire configuring and commissioning device 50 may be operative to determine that the one of the luminaires 11, 21, 31 for which the received radio signal amplitude is strongest is the luminaire that has coordinates that are closest to the current position of the luminaire configuring and commissioning device 50. Thereby, luminaire addresses and luminaire coordinates may be brought into correspondence with one another.

The luminaire configuring and commissioning device 50 may have a radio interface to receive radio signals 151, 152, 153 transmitted by the luminaires 11, 21, 31. The luminaire configuring and commissioning device 50 may have an optical sensor or any other receiver that is operative to receive signals from the luminaires 11, 21, 31 in which the luminaire addresses in the lighting system 10 are encoded.

Irrespective of whether or not the luminaire configuring and commissioning device 50 determines the correspondence between luminaire actresses and luminaire positions, e.g. using the techniques outlined above, the luminaire configuring and commissioning device 50 may be operative to generate an electronic map which does not only show luminaire positions but which also shows the luminaire addresses in the lighting system displayed on the electronic map.

The luminaire configuring and commissioning device 50 may allow an engineer to select one or several luminaires by their addresses or positions. The luminaire configuring and commissioning device 50 may allow the engineer to configure individual luminaires that have been selected by the engineer on the luminaire configuring and commissioning device 50. Alternatively or additionally, the luminaire configuring and commissioning device 50 may allow the engineer to assign one or several luminaires to groups or light scenes in commissioning the lighting system 10. The luminaire configuring and commissioning device 50 may be operative to generate a radio signal 156 for transmission to the control device 4 of the lighting system 10. The radio signal 156 may include configuration data for configuring individual ones of the luminaires or may include commissioning data that assigns several luminaires to respectively one group or one light scene.

FIG. 14 is a schematic diagram of a luminaire configuring and commissioning device 50 according to an embodiment.

The luminaire configuring and commissioning device 50 may have a radio interface 51 operative to receive signals 151, 152, 153 from the luminaires 11, 21, 31. The luminaire configuring and commissioning device 50 may have a processing device 52 that may be operative to associate address information received from the luminaires 11, 21, 31 respectively this position data of the luminaires. In this process, each address may be associated with one of the predetermined positions of luminaires. The luminaire positions may be determined using any one of the techniques described with reference to FIG. 1 to FIG. 12 or any other technique.

The luminaire configuring and commissioning device 50 may have a storage device 55 which stores a table or other data structure that associates luminaire address information in the lighting system 10 with respectively one luminaire coordinate n-tuple, e.g. with a pair of luminaire coordinates or with a triplet of luminaire coordinates.

The data structure stored in the storage device 55 may be determined autonomously by the luminaire configuring and commissioning device 50 or may be received by the luminaire configuring and commissioning device 50 from another device.

The luminaire configuring and commissioning device 50 may have an optical output device 54. The processing device 52 may be operative to control the optical output device 54 to display an electronic map 161. The electronic map 161 may be generated by the luminaire configuring and commissioning device 50 such that it displays luminaire positions and, additionally, the addresses 161, 162, 163, 164 at the positions that correspond to the luminaires. Thereby, the addresses of luminaires assigned to the luminaires in the lighting system may be output in an intuitive way such that the engineer operating the luminaire configuring and commissioning device 50 may immediately understand which address is respectively assigned in the lighting system 10 to any one of the various luminaires in the lighting system 10. The acts of configuring the luminaires and commissioning the lighting system 10 may be greatly simplified thereby.

The luminaire configuring and commissioning device 50 may be operative to allow an engineer using the luminaire configuring and commissioning device 50 to select individual ones of the luminaires displayed on the electronic map 161. The luminaire configuring and commissioning device 50 may allow the operator to input data for configuring the selected one of the luminaires. Configuration data associated with the address information 161, 162, 163, 164 of the luminaire in the lighting system may be transmitted to the control device for or the luminaire, for example.

The luminaire configuring and commissioning device 50 may be operative to allow an engineer to select several ones of the luminaires displayed on the electronic map 161. The luminaire configuring and commissioning device 50 may allow the operator to assign the selected several luminaires to a group or light scene. Commissioning data which defines to which groups or light scenes each one of the luminaires has been assigned may be transmitted by the luminaire configuring and commissioning device 50 the control device 4.

The luminaire configuring and commissioning device 50 may comprise a commissioning controller 53 that is operative to control the radio interface 51 to transmit a commissioning signal in which commissioning data is encoded to define to which groups or light scenes each one of the luminaires has been assigned.

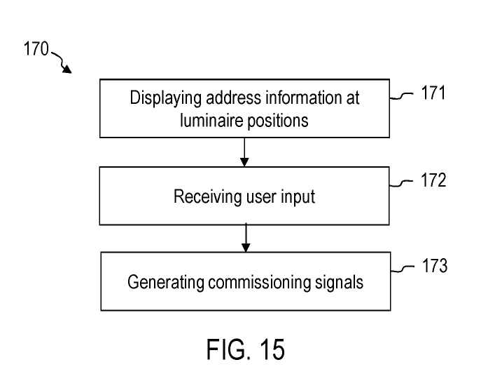

FIG. 15 is a flowchart of a method 170 according to an embodiment. The method 170 may be performed by the luminaire configuring and commissioning device 50 according to an embodiment. The method 170 may be performed to allow the lighting system 10 to be commissioned after it has been installed.

At 171, the luminaire configuring and commissioning device 50 generates an electronic map in which address information of luminaires is displayed in accordance with the positions at which the respective luminaires are installed. The electronic map may additionally include a footprint of the room in which the luminaires are installed. The electronic map may optionally also include information on windows or doorways of the room.

At 172, the luminaire configuring and commissioning device 50 receives a user input. The user input may assign several luminaires to a group or light scene. The user input may define, in a time-sequential manner, a plurality of groups or plurality of light scenes and the luminaires that are respectively assigned to the group or the light scene.

At 173, the luminaire configuring and commissioning device 50 may generate commissioning signals for transmission to the control device 4 of the lighting system 10. The commissioning signals may carry commissioning data that defines, for each one of the luminaires, to which groups or light scenes the respective luminaire has been assigned.

The luminaire configuring and commissioning device 50 may be implemented as a smartphone, a portable computer, or another handheld device that executes instructions for commissioning a lighting system 10.

While embodiments have been described with reference to the drawings, modifications and alterations may be implemented in further embodiments. For illustration, while a portable device 50 may be operative to both perform a luminaire locating procedure in which luminaire locations are determined and a commissioning procedure in which they determined luminaire locations are used for commissioning the lighting system, the acts of determining luminaire positions and of commissioning the lighting system may be distributed over plural different devices.

While embodiments have been described in which a luminaire locating device is operative to determine luminaire positions based on intensity information captured by optical sensors, the luminaire locating device may optionally take into account additional information such as information on floorplans retrieved over a wide area network or otherwise. The luminaire locating device may perform the localization of the luminaires based on color information and/or modulation of light. This allows the various luminaires to be distinguished more easily, also when several luminaires are operated simultaneously during the self-localization procedure.

The intensity information received by a luminaire locating device may include or may be a color value that reflects relative intensitites captured in different color channels of an optical sensor, and/or modulation information that reflects a time-dependent intensity variation detected by an optical sensor.

It will be appreciated that the techniques disclosed herein do not require each luminaire of a lighting system to be provided with an optical sensor. For illustration, the techniques of automatically determining positions of luminaires of a lighting system may also be performed when only a sub-set of luminaires installed in a room is equipped with an optical sensor. The techniques of automatically determining positions of luminaires may be performed using three, four, or more optical sensors, each of which is mounted in or on a luminaire.

It will be appreciated that the optical sensors may be arranged at various positions of a luminaire. For illustration, for a luminaire that includes an LED module and a converter coupled thereto, the optical sensor may be mounted to the LED module or the converter. For a luminaire which is a retrofit bulb, the optical sensor may be mounted within a translucent shell of the retrofit bulb.

Although the invention has been shown and described with respect to certain preferred embodiments, equivalents and modifications will occur to others skilled in the art upon the reading and understanding of the specification. The present invention includes all such equivalents and modifications, and is limited only by the scope of the following claims.

1. A luminaire locating device, comprising:
an interface to receive intensity information captured by a plurality of optical sensors; and
an electronic processing device comprising at least one integrated circuit to locate luminaires of a lighting system by processing the intensity information captured by the plurality of optical sensors.

2. The luminaire locating device of claim 1,
the electronic processing device being operative to locate the luminaires by triangulation based on the intensity information captured by the plurality of optical sensors.

3. The luminaire locating device of claim 1,
the electronic processing device being operative to locate the luminaires by matching the intensity information captured by the plurality of optical sensors to intensity patterns stored in a non-transitory storage medium.

4. The luminaire locating device of claim 1,
the luminaire locating device being operative to locate the luminaires relative to a footprint of at least one room in which the luminaires are installed.

5. The luminaire locating device of claim 4,
the luminaire locating device being operative to process the intensity information to derive the footprint of the at least one room.

6. The luminaire locating device of claim 4,
the luminaire locating device being operative to process the intensity information to derive locations of at least one of
wall of the at least one room;
windows of the at least one room;
doors of the at least one room
by processing the intensity information.

7. The luminaire locating device of claim 4,
the luminaire locating device being operative to retrieve the footprint.

8. The luminaire locating device of claim 7,
the luminaire locating device being operative to retrieve the footprint over a wide area network.

9. The luminaire locating device of claim 1,
the luminaire locating device being operative to generate a three-dimensional map including three-dimensional positions of the luminaires by processing the intensity information captured by the plurality of optical sensors.

10. The luminaire locating device of claim 1,
an optical sensor of the plurality of optical sensors being integrated in an associated one of the luminaires.

11. The luminaire locating device of claim 10,
the plurality of optical sensors including at least one camera chip.

12. The luminaire locating device of claim 1,
the luminaire locating device being operative for commissioning the lighting system.

13. A system, comprising:
the luminaire locating device of claim 1; and
a plurality of luminaires, at least three of the luminaires comprising an associated optical sensor and an interface to transmit intensity information captured by the associated optical sensor.

14. A luminaire, comprising:
at least one light-emitting diode;
an optical sensor to capture intensity information; and
an interface to transfer the intensity information for execution of a self-localization procedure.

15. The luminaire of claim 14,
the optical sensor comprising a light sensor or a camera chip.

16. A luminaire configuring and commissioning device, comprising:
a storage medium which stores luminaire address information and luminaire position information for each luminaire of a plurality of luminaires; and
an optical output device to output the luminaire address information of at least one luminaire of the plurality of luminaires on an electronic map.

17. The luminaire configuring and commissioning device of claim 16,
the optical output device being operative to output the luminaire address information for each luminaire of the plurality of luminaires on the electronic map.

18. The luminaire configuring and commissioning device of claim 17,
the optical output device comprising an input interface to enable selection of a group of luminaires for commissioning.

19. The luminaire configuring and commissioning device of claim 16, further comprising:
a control interface to output a command for configuring or commissioning a lighting system, the command being generated as a function of the luminaire address information.

20. The luminaire configuring and commissioning device of claim 16,
wherein the electronic map comprises at least one of a room footprint, a floor footprint, or a building footprint.
a positioning device to determine coordinates of the plurality of luminaire; and
a processing device comprising at least one integrated circuit to write information on the address information of each luminaire and respectively associated luminaire coordinates into a table.

21. A method of locating luminaires of a lighting system, the method comprising:
receiving, by an interface of a luminaire locating device, intensity information captured by a plurality of optical sensors; and
processing, by at least one integrated circuit of the luminaire locating device, the intensity information captured by the plurality of optical sensors to locate the luminaires of the lighting system.
